(19) United States
(12) Patent Application Publication
(10) Pub. No.: US 2025/0150387 A1
(43) Pub. Date: May 8, 2025

(54) COMMUNICATION SYSTEM, ROUTING CONTROL APPARATUS, AND ROUTING CONTROL METHOD

(71) Applicant: NIPPON TELEGRAPH AND TELEPHONE CORPORATION, Tokyo (JP)

(72) Inventors: Tomoya HATANO, Musashino-shi, Tokyo (JP); Hiroshi O, Musashino-shi, Tokyo (JP); Takashi YAMADA, Musashino-shi, Tokyo (JP); Hirotaka UJIKAWA, Musashino-shi, Tokyo (JP); Yushi KOYASAKO, Musashino-shi, Tokyo (JP)

(73) Assignee: NIPPON TELEGRAPH AND TELEPHONE CORPORATION, Tokyo (JP)

(21) Appl. No.: 18/838,124

(22) PCT Filed: Feb. 17, 2022
(86) PCT No.: PCT/JP2022/006392

§ 371 Date: Aug. 13, 2024

(51) Int. Cl. H04L 45/302; H04L 45/121; H04L 45/42

(52) U.S. Cl. CPC H04L 45/302; H04L 45/121; H04L 45/42

(57) ABSTRACT

Provided is a communication system in which a plurality of networks each having a detour within an end-to-end distance are formed, the communication system including: a plurality of section control units that perform path control for each of sections with a network having a detour, the sections being obtained by partitioning the communication system; and an integrated control unit that controls the plurality of section control units, in which the integrated control unit includes an optimization unit that determines an optimal guaranteed delay time for each section to satisfy an end-to-end guaranteed delay time provided by a service, and a notification unit that notifies the plurality of section control units of the optimal guaranteed delay time for each section determined by the optimization unit, and the plurality of section control units each include a switching destination instruction unit that instructs a switching destination to switch to a path satisfying the optimal guaranteed delay time notified from the integrated control unit.

### TECHNICAL FIELD

The present invention relates to a communication system, a path control device, and a path control method.

### BACKGROUND ART

In a general communication network, when a packet is delivered to its destination, the packet is transferred through multiple stages of communication devices that relay the packet. When a packet passes through multiple stages of communication devices, the delay increases until the packet reaches the destination. Therefore, a technique for guaranteeing end-to-end delay has been proposed (for example, see PTL 1). PTL 1 proposes a technique for prioritizing reading within a specified path and keeping the delay time below an end-to-end guaranteed delay time (service level agreement (SLA) value) provided by the service.

### CITATION LIST

### Patent Literature

[PTL 1] Japanese Patent Application Publication No. 2019-118072

### SUMMARY OF INVENTION

### Technical Problem

However, when the delay increases due to congestion or the like in the communication device through which the packet passes, it may not be possible to satisfy the guaranteed delay time only with the priority of reading. As a result, it has sometimes been difficult to provide a service that satisfies the guaranteed delay time.

In view of the above-mentioned circumstances, an object of the present invention is to provide a technique capable of providing a service that satisfies a guaranteed delay time even when delay increases in a communication device through which a packet passes within an end-to-end distance.

### Solution to Problem

According to one aspect of the present invention, there is provided a communication system in which a plurality of networks each having a detour within an end-to-end distance are formed, the communication system including: a plurality of section control units that perform path control for each of sections with a network having a detour, the sections being obtained by partitioning the communication system; and an integrated control unit that controls the plurality of section control units, in which the integrated control unit includes an optimization unit that determines an optimal guaranteed delay time for each section to satisfy an end-to-end guaranteed delay time provided by a service, and a notification unit that notifies the plurality of section control units of the optimal guaranteed delay time for each section determined by the optimization unit, and the plurality of section control units each include a switching destination instruction unit that instructs a switching destination to switch to a path satisfying the optimal guaranteed delay time notified from the integrated control unit.

According to one aspect of the present invention, there is provided a path control device in a communication system in which a plurality of networks each having a detour within an end-to-end distance are formed, the communication system being partitioned into a plurality of sections with a network having a detour, and the path control device including: an optimization unit that determines an optimal guaranteed delay time for each section to satisfy an end-to-end guaranteed delay time provided by a service; and a switching destination instruction unit that instructs a switching destination for each section to switch to a path satisfying the optimal guaranteed delay time determined by the optimization unit.

According to one aspect of the present invention, there is provided a path control method in a communication system in which a plurality of networks each having a detour within an end-to-end distance are formed, the communication system being partitioned into a plurality of sections with a network having a detour, and the path control method including: determining an optimal guaranteed delay time for each section to satisfy an end-to-end guaranteed delay time provided by a service; and instructing a switching destination for each section to switch to a path satisfying the determined optimal guaranteed delay time.

### Advantageous Effects of Invention

According to the present invention, even when delay increases in a communication device through which a packet passes within an end-to-end distance, it is possible to provide a service that satisfies a guaranteed delay time.

### BRIEF DESCRIPTION OF DRAWINGS

FIG. 1 is a diagram illustrating a configuration example of a communication system according to the present embodiment.

FIG. 2 is a diagram illustrating an example of a functional configuration of an integrated control unit according to the present embodiment.

FIG. 3 is a diagram for describing a method of determining an optimal section service level agreement (SLA) value performed by a section SLA optimization unit according to the present embodiment.

FIG. 4 is a diagram illustrating an example of a functional configuration of a section control unit according to the present embodiment.

FIG. 5 is a sequence diagram illustrating a flow of processing of the communication system according to the present embodiment.

FIG. 6 is a sequence diagram illustrating a flow of processing of the communication system according to the present embodiment.

FIG. 7 is a diagram illustrating a configuration example of a communication system according to a modification example.

### DESCRIPTION OF EMBODIMENTS

An embodiment of the present invention will be described below with reference to the drawings.

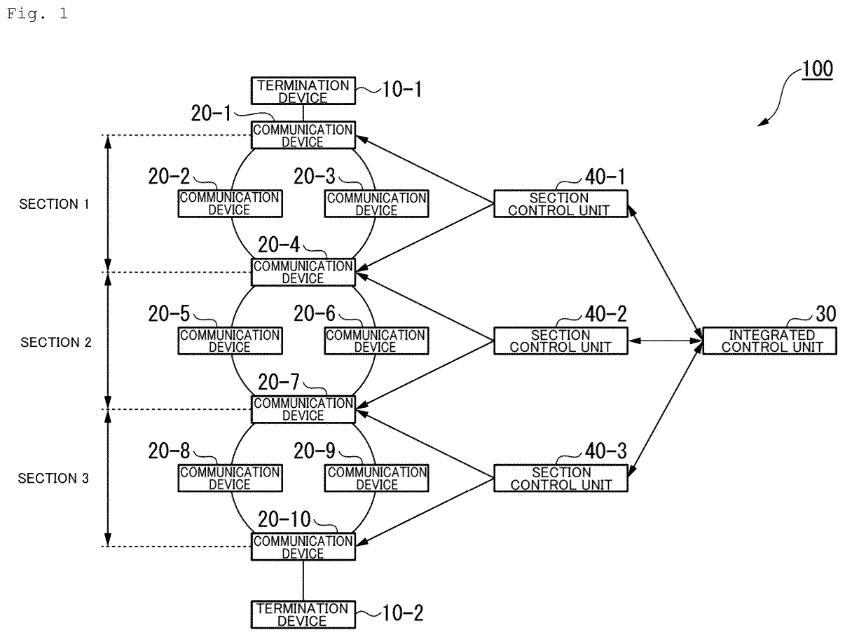

FIG. 1 is a diagram illustrating a configuration example of a communication system 100 according to the present embodiment.

The communication system 100 includes a plurality of termination devices 10-1 and 10-2, a plurality of communication devices 20-1 to 20-10, an integrated control unit 30, and a plurality of section control units 40-1 to 40-3. As illustrated in FIG. 1, in the communication system 100 according to the present embodiment, a plurality of networks having detours are formed within an end-to-end distance. The network having a detour is, for example, a mesh network or a ring network.

In the example illustrated in FIG. 1, the communication devices 20-1 to 20-4 form one ring network (hereinafter referred to as a “first NW”), the communication devices 20-4 to 20-7 form one ring network (hereinafter referred to as a “second NW”), and the communication devices 20-7 to 20-10 form one ring network (hereinafter referred to as a “third NW”). That is, the communication system 100 illustrated in FIG. 1 shows an example in which the first NW is connected to the termination device 10-1, the second NW is connected to the first NW, the third NW is connected to the second NW, and the termination device 10-2 is connected to the third NW.

The communication system 100 according to the present embodiment provides a service that satisfies a guaranteed delay time by end-to-end (the termination device 10-1 and the termination device 10-2) partitioning into a plurality of sections at arbitrary points and performing path control for each section. As a method of partitioning an end-to-end distance into a plurality of sections at arbitrary points, for example, it is conceivable to partition the end-to-end distance into a plurality of sections at a hub point in the path within an end-to-end distance or at a network boundary. More specifically, it is conceivable to partition the end-to-end distance into a plurality of sections at a joint point of rings in the case of a ring network, or at a boundary between autonomous systems (ASs) in the case of a border gateway protocol (BGP) network.

In the present embodiment, the end-to-end distance is partitioned into a plurality of sections at the joint point between the first NW and the second NW (for example, the position of the communication device 20-4) and the joint point between the second NW and the third NW (for example, the position of the communication device 20-7). In the following description, it is assumed that the first NW belongs to a section 1, the second NW belongs to a section 2, and the third NW belongs to a section 3.

In the following description, the termination devices 10-1 and 10-2 will be referred to as a termination device 10 unless they are particularly distinguished, the communication devices 20-1 to 20-10 will be referred to as a communication device 20 unless they are particularly distinguished, and the section control units 40-1 to 40-3 will be referred to as a section control unit 40 unless they are particularly distinguished. The numbers of termination devices 10, communication devices 20, and section control units 40 included in the communication system 100 only need to be two or more, and are not limited to the numbers illustrated in FIG. 1. For example, the number of section control units 40 may be as many as the number of sections.

The termination devices 10-1 and 10-2 are devices that perform end-to-end communication. The termination devices 10-1 and 10-2 are devices that are a transmission source or a transmission destination of a packet.

The communication device 20 transfers the packet transmitted from the termination device 10 to the termination device 10 of the destination. When the section control unit 40 issues a path switching instruction, the communication device 20 transfers the packet to the communication device 20 on the instructed path. When the section control unit 40 does not issue a path switching instruction, the communication device 20 transfers the packet to the communication device 20 on a predetermined path.

The integrated control unit 30 controls the section control units 40-1 to 40-3 to satisfy an end-to-end guaranteed delay time (service level agreement (SLA) value) provided by the service. Specifically, the integrated control unit 30 divides the SLA value into a minimum required section SLA value (hereinafter referred to as a “minimum section SLA value”) of each section, and notifies the section control units 40-1 to 40-3 of the minimum section SLA value. Here, the minimum section SLA value is a delay time which can be allowed in each section.

The section control units 40-1 to 40-3 are provided for each section and control the transfer path of the packet to guarantee the minimum section SLA value assigned from the integrated control unit 30. In the present embodiment, the section control unit 40-1 controls the transfer path of the packet in the section 1, the section control unit 40-2 controls the transfer path of the packet in the section 2, and the section control unit 40-3 controls the transfer path of the packet in the section 3.

Specifically, the section control unit 40 measures a delay time of a packet in a section, and controls the transfer path to detour the packet when the delay time exceeds a minimum section SLA value. After checking the congestion state or the total low delay time of the detour destination and switching the path, the section control unit 40 switches the path after confirming that the delay time of the packet is within the time indicated by the minimum section SLA value. When a plurality of detours are provided, the section control unit 40 selects one of the paths satisfying the minimum section SLA value and performs switching.

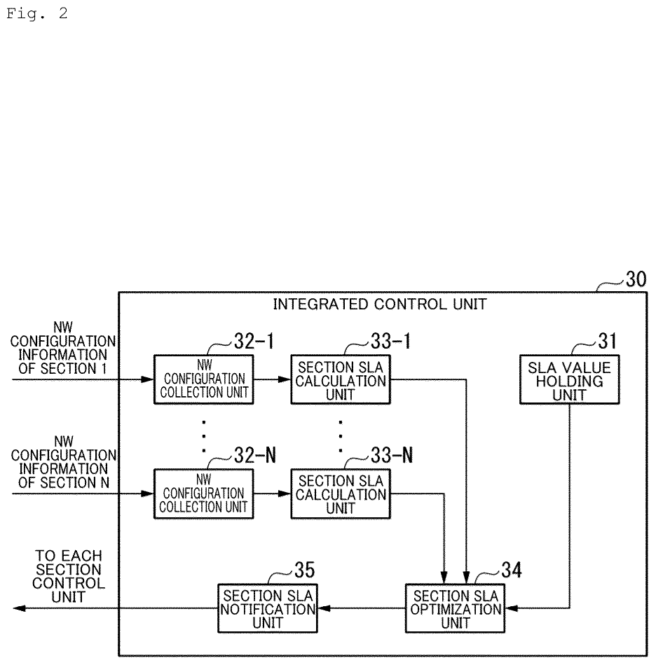

FIG. 2 is a diagram illustrating an example of a functional configuration of the integrated control unit 30 according to the present embodiment.

The integrated control unit 30 includes an SLA value holding unit 31, NW configuration collection units 32-1 to 32-N, section SLA calculation units 33-1 to 33-N, a section SLA optimization unit 34, and a section SLA notification unit 35. N is an integer of 2 or more, and corresponds to the number of section control units 40 (the number of section control units is 3 in FIG. 1). In the following description, the case where N is 3 will be described as an example.

The SLA value holding unit 31 holds an SLA value which is an end-to-end guaranteed delay time provided by the service. The SLA value holding unit 31 may acquire and hold the SLA value from an external functional unit. The SLA value holding unit 31 outputs the held SLA value to the section SLA optimization unit 34 in response to a request from the section SLA optimization unit 34.

The NW configuration collection unit 32-n (1≤n≤N) acquires configuration information (distance, number of devices, band, etc.) of the section managed by the section control unit 40-n from the section control unit 40-n. For example, the NW configuration collection unit 32-1 acquires configuration information of the section 1 from the section control unit 40-1 that manages the section 1.

The section SLA calculation unit 33-n calculates a minimum section SLA value in the section on the basis of the configuration information acquired by the NW configuration collection unit 32-n. For example, the section SLA calculation unit 33-1 acquires configuration information of the section 1 from the NW configuration collection unit 32-1, and calculates a minimum section SLA value in the section 1 on the basis of the acquired configuration information of the section 1.

The section SLA optimization unit 34 determines an optimal section SLA value of each section on the basis of the SLA value held by the SLA value holding unit 31 and the minimum section SLA value of each section calculated by each of the section SLA calculation units 33-1 to 33-N. Specifically, the section SLA optimization unit 34 compares the total sum of the minimum section SLA values of each section with the SLA value, and determines the optimal section SLA value of each section based on the comparison result. The section SLA optimization unit 34 is one aspect of an optimization unit.

When the total sum of the minimum section SLA values of each section and the SLA value are the same value, the section SLA optimization unit 34 determines the minimum section SLA value of each section as the optimal section SLA value of each section.

When the total sum of the minimum section SLA values of each section is less than the SLA value, the section SLA optimization unit 34 determines the optimal section SLA value of each section by adding a value obtained by proportionally dividing a surplus to the minimum section SLA value of each section. The surplus mentioned herein is a value obtained by subtracting the SLA value from the total sum of the minimum section SLA values of each section. The proportional division method includes an equal division method, a weighting method, a calculation method from configuration information, and the like.

The equal division method is a method of equally allocating the surplus to each section. The weighting method is a method of allocating the surplus according to the proportion of the minimum section SLA value of each section. The calculation method from configuration information is a method of allocating a larger amount of surplus to a section where it is estimated that there is a high likelihood that the status of the network will fluctuate by referring to the configuration information than a section where there is a low likelihood that the status of the network will fluctuate. The section where it is estimated that there is a high likelihood that the status of the network will fluctuate is estimated on the basis of conditions such as, for example, a larger number of devices than other sections, a longer distance of the section than other sections, and a narrower band than other sections.

When the total sum of the minimum section SLA values of each section exceeds the SLA value, the section SLA optimization unit 34 determines that the service cannot be provided, and ends the processing.

The section SLA notification unit 35 notifies the section control units 40-1 to 40-3 of the optimal section SLA value of each section determined by the section SLA optimization unit 34. The section SLA notification unit 35 is one aspect of a notification unit.

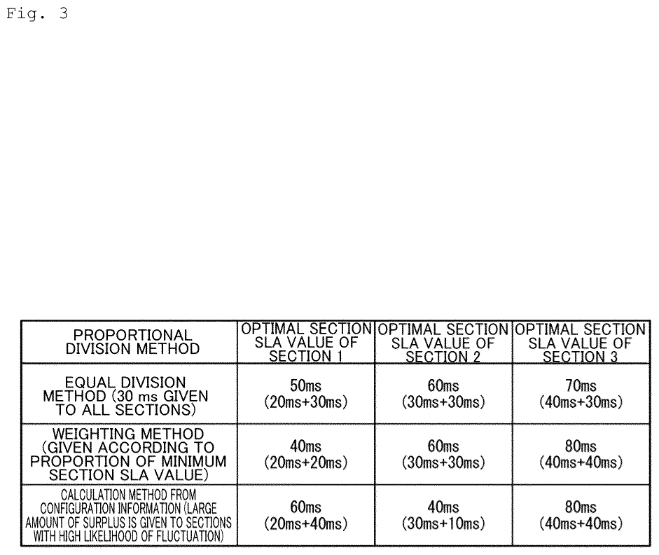

Next, a method of determining an optimal section SLA value performed by the section SLA optimization unit 34 will be described. FIG. 3 is a diagram for describing a method of determining an optimal section SLA value performed by the section SLA optimization unit 34 according to the present embodiment. When the total sum of the minimum section SLA values of each section and the SLA value are the same value, the minimum section SLA value of each section is determined as the optimal section SLA value of each section. Therefore, in FIG. 3, a method of calculating the optimal section SLA value of each section when the total sum of the minimum section SLA values of each section is less than the SLA value will be described.

As a premise of the description using FIG. 3, the case where the SLA value held by the SLA value holding unit 31 is “180 ms,” the minimum section SLA value of the section 1 is “20 ms,” the minimum section SLA value of the section 2 is “30 ms,” and the minimum section SLA value of the section 3 is “40 ms” will be described as an example. In this case, the total sum of the minimum section SLA values of each section is “20 ms”+“30 ms”+“40 ms” = “90 ms.”

As described above, when the total sum of the minimum section SLA values of each section is less than the SLA value, the section SLA optimization unit 34 determines the optimal section SLA value of each section by adding a value obtained by proportionally dividing the surplus to the minimum section SLA value of each section. FIG. 3 illustrates the optimal section SLA values of each section obtained by the equal division method, the weighting method, and the determination method from configuration information.

First, a method of determining an optimal section SLA value of each section using the equal division method will be described. First, the section SLA optimization unit 34 subtracts the total sum “90 ms” of the minimum section SLA values of each section from the SLA value “180 ms.” Accordingly, the surplus “90 ms” is calculated. Next, the section SLA optimization unit 34 performs proportional division such that the surplus “90 ms” is equally allocated to three sections. Thus, the value of “30 ms” is allocated to the three sections. The section SLA optimization unit 34 determines the optimal section SLA value of each section by adding the value of “30 ms” to the minimum section SLA value of each section.

For example, since the minimum section SLA value of the section 1 is “20 ms,” the section SLA optimization unit 34 determines “50 ms” (“20 ms”+“30 ms”) as the optimal section SLA value of the section 1. Similarly, since the minimum section SLA value of the section 2 is “30 ms,” the section SLA optimization unit 34 determines “60 ms” (“30 ms”+“30 ms”) as the optimal section SLA value of the section 2. Similarly, since the minimum section SLA value of the section 3 is “40 ms,” the section SLA optimization unit 34 determines “70 ms” (“40 ms”+“30 ms”) as the optimal section SLA value of the section 3.

Next, a method of determining an optimal section SLA value of each section using the weighting method will be described. First, the section SLA optimization unit 34 subtracts the total sum “90 ms” of the minimum section SLA values of each section from the SLA value “180 ms.” Accordingly, the surplus “90 ms” is calculated. Next, the section SLA optimization unit 34 proportionally divides the surplus “90 ms” according to the proportion of the minimum section SLA value of each section. Since the minimum section SLA value of the section 1 is “20 ms,” the minimum section SLA value of the section 2 is “30 ms,” and the minimum section SLA value of the section 3 is “40ms,” a value of “20 ms” is allocated to the section 1, a value of “30 ms” is allocated to the section 2, and a value of “40 ms” is allocated to the section 3. The section SLA optimization unit 34 determines the optimal section SLA value of each section by adding the proportionally divided value to the minimum section SLA value of each section.

For example, since the minimum section SLA value of the section 1 is “20 ms,” the section SLA optimization unit 34 determines “40 ms” (“20 ms”+“20 ms”) as the optimal section SLA value of the section 1. Similarly, since the minimum section SLA value of the section 2 is “30 ms”, the section SLA optimization unit 34 determines “60 ms” (“30 ms”+“30 ms”) as the optimal section SLA value of the section 2. Similarly, since the minimum section SLA value of the section 3 is “40 ms,” the section SLA optimization unit 34 determines “80 ms” (“40 ms”+“40 ms”) as the optimal section SLA value of the section 3.

Next, a method of determining an optimal section SLA value of each section using the determination method from configuration information will be described. First, the section SLA optimization unit 34 subtracts the total sum “90 ms” of the minimum section SLA values of each section from the SLA value “180 ms.” Accordingly, the surplus “90 ms” is calculated. Next, the section SLA optimization unit 34 proportionally divides the surplus “90 ms” on the basis of the configuration information of each section. Here, it is assumed that the section 1 and the section 3 are sections where it is estimated that there is a high likelihood that the status of the network will fluctuate. In this case, the section SLA optimization unit 34 performs proportional division such that the surplus “90 ms” is allocated to the sections 1 and 3 more than the section 2. For example, the section SLA optimization unit 34 proportionally divides the surplus “90 ms” such that “40 ms” is allocated to the sections 1 and 3, respectively, and “10 ms” is allocated to the section 2. The section SLA optimization unit 34 determines the optimal section SLA value of each section by adding the proportionally divided value to the minimum section SLA value of each section.

For example, since the minimum section SLA value of the section 1 is “20 ms,” the section SLA optimization unit 34 determines “60 ms” (“20 ms”+“40 ms”) as the optimal section SLA value of the section 1. Similarly, since the minimum section SLA value of the section 2 is “30 ms,” the section SLA optimization unit 34 determines “40 ms” (“30 ms”+“10 ms”) as the optimal section SLA value of the section 2. Similarly, since the minimum section SLA value of the section 3 is “40 ms”, the section SLA optimization unit 34 determines “80 ms” (“40 ms”+“40 ms”) as the optimal section SLA value of the section 3.

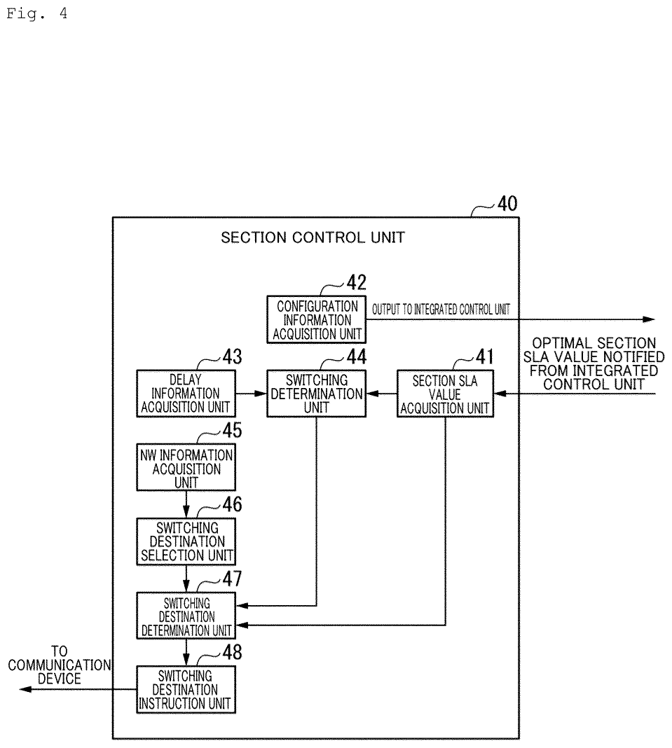

FIG. 4 is a diagram illustrating an example of a functional configuration of the section control unit 40 according to the present embodiment. Note that each section control unit 40 has the same configuration. In the case of describing the functional unit of a certain section control unit 40, a branch number is added to distinguish the functional unit. For example, in the case of describing the functional unit of the section control unit 40-1, the functional unit number is followed by a branch number “-1” for distinction.

The section control unit 40 includes a section SLA value acquisition unit 41, a configuration information acquisition unit 42, a delay information acquisition unit 43, a switching determination unit 44, an NW information acquisition unit 45, a switching destination selection unit 46, a switching destination determination unit 47, and a switching destination instruction unit 48.

The section SLA value acquisition unit 41 acquires the optimal section SLA value notified by the integrated control unit 30.

The section SLA value acquisition unit 41 notifies the switching determination unit 44 and the switching destination determination unit 47 of the acquired optimal section SLA value.

The configuration information acquisition unit 42 holds configuration information of the section managed by the section control unit 40. The configuration information acquisition unit 42 may acquire and hold the configuration information of the section from an external functional unit. The configuration information acquisition unit 42 notifies the integrated control unit 30 of the configuration information of the held section.

The delay information acquisition unit 43 acquires information (hereinafter referred to as “delay information”) regarding the delay time of the path through which the packet passes among the paths in the section managed by the section control unit 40. The delay information acquisition unit 43 may acquire delay information by measuring the delay in the section of the path through which the packet passes among the sections managed by the section control unit 40, or may acquire delay information from an external function.

The switching determination unit 44 determines whether or not switching of the path is necessary on the basis of the optimal section SLA value notified from the section SLA value acquisition unit 41 and the delay time indicated by the delay information output from the delay information acquisition unit 43. Specifically, the switching determination unit 44 determines that switching of the path is necessary when the delay time indicated by the delay information exceeds the optimal section SLA value. On the other hand, when the delay time indicated by the delay information is equal to or less than the optimal section SLA value, the switching determination unit 44 determines that switching of the path is unnecessary. When it is determined that switching of the path is necessary, the switching determination unit 44 outputs a notification indicating that switching of the path is necessary to the switching destination determination unit 47.

The NW information acquisition unit 45 acquires NW information of a path through which no packet passes at present in the section managed by the section control unit 40. The NW information is information indicating the connection relationship or the like of the communication device 20 on a path through which no packet passes at present.

The switching destination selection unit 46 selects a path that is a switchable candidate of a switching destination (hereinafter referred to as a “candidate path”) on the basis of the NW information notified from the NW information acquisition unit 45. Further, the switching destination selection unit 46 estimates a delay in the selected candidate path for each candidate path. The switching destination selection unit 46 may estimate the delay in the candidate path by transmitting and receiving a control frame in the candidate path to measure a delay time and calculating the delay time before and after switching. Hereinafter, the delay estimated by the switching destination selection unit 46 will be referred to as an estimated delay time.

The switching destination determination unit 47 determines a path to be a switching destination when receiving a notification indicating that switching is necessary from the switching determination unit 44. Specifically, the switching destination determination unit 47 determines, as a switching destination path, a candidate path in which the estimated delay time of the candidate path is less than the section SLA value notified from the section SLA value acquisition unit 41 among the candidate paths notified from the switching destination selection unit 46. When there are a plurality of candidate paths in which the estimated delay time of the candidate path is less than the section SLA value notified from the section SLA value acquisition unit 41, the switching destination determination unit 47 determines the candidate path having the smallest estimated delay time as the switching destination path.

The switching destination instruction unit 48 generates a switching instruction including the information of the switching destination path notified from the switching destination determination unit 47. The switching destination instruction unit 48 transmits the generated switching instruction to the communication device 20 in the section managed by the section control unit 40. In this way, the switching destination instruction unit 48 switches the communication NW by instructing to switch the transfer path of the packet to the switching destination path notified from the switching destination determination unit 47.

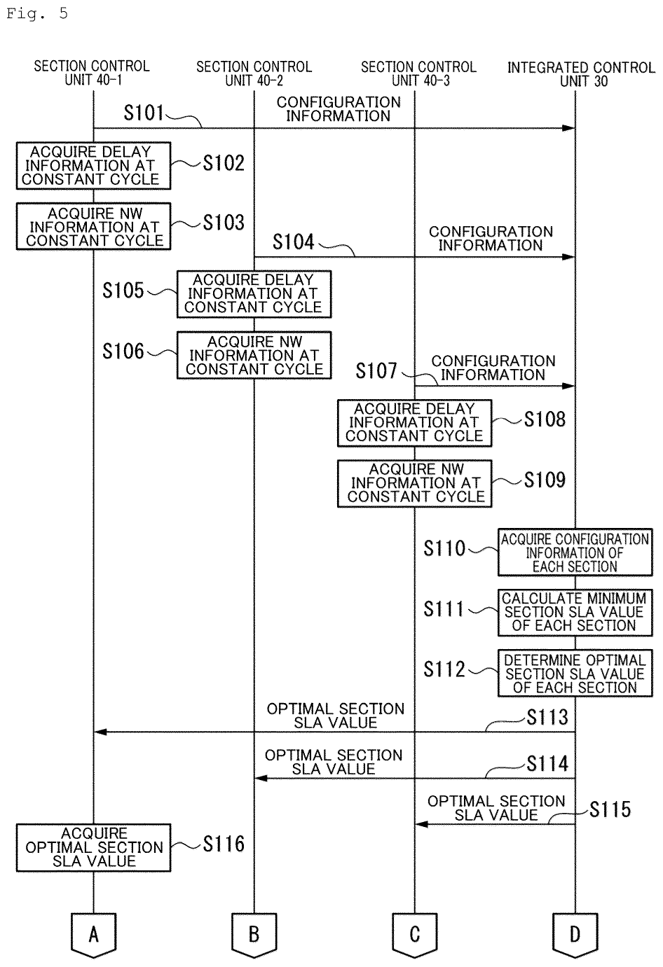

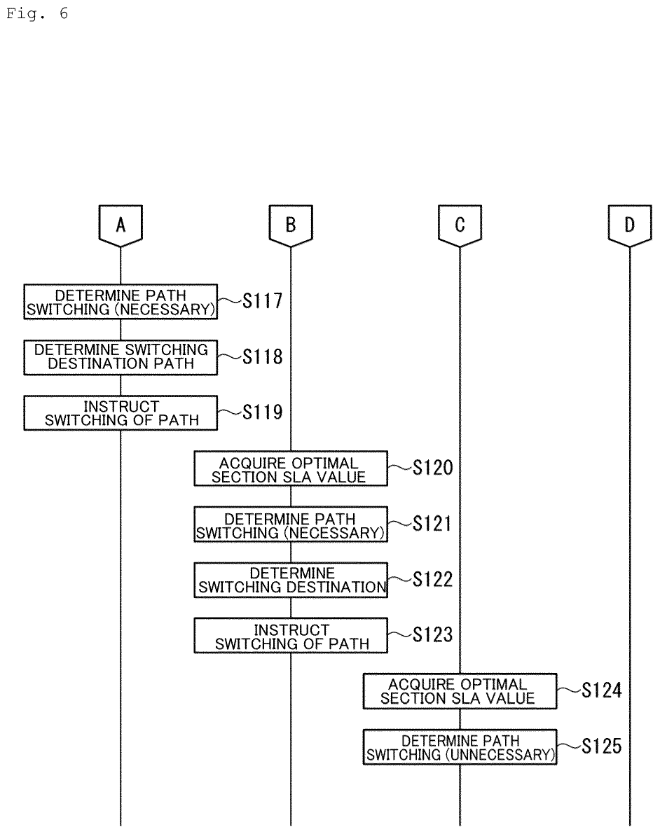

FIGS. 5 and 6 are sequence diagrams illustrating a flow of processing of the communication system 100 according to the present embodiment.

A configuration information acquisition unit 42-1 of the section control unit 40-1 notifies the integrated control unit 30 of configuration information of a section 1 (step S101). A delay information acquisition unit 43-1 of the section control unit 40-1 acquires delay information of a path through which a packet passes among paths in the section 1 at a constant cycle (step S102). Each time the delay information is acquired, the delay information acquisition unit 43-1 outputs the acquired delay information to a switching determination unit 44-1.

An NW information acquisition unit 45-1 of the section control unit 40-1 acquires NW information of a path through which no packet passes at present in the section 1 at a constant cycle (step S103). Each time the NW information is acquired, the NW information acquisition unit 45-1 outputs the acquired NW information to a switching destination selection unit 46-1. Each time the NW information acquired from the NW information acquisition unit 45-1, the switching destination selection unit 46-1 selects a switching destination path.

Similarly, a configuration information acquisition unit 42-2 of the section control unit 40-2 notifies the integrated control unit 30 of configuration information of a section 2 (step S104). A delay information acquisition unit 43-2 of the section control unit 40-2 acquires delay information of a path through which a packet passes among paths in the section 2 at a constant cycle (step S105). Each time the delay information is acquired, the delay information acquisition unit 43-2 outputs the acquired delay information to a switching determination unit 44-2.

An NW information acquisition unit 45-2 of the section control unit 40-2 acquires NW information of a path through which no packet passes at present in the section 2 at a constant cycle (step S106). Each time the NW information is acquired, the NW information acquisition unit 45-2 outputs the acquired NW information to a switching destination selection unit 46-2. Each time the NW information acquired from the NW information acquisition unit 45-2, the switching destination selection unit 46-2 selects a switching destination path.

Similarly, a configuration information acquisition unit 42-3 of the section control unit 40-3 notifies the integrated control unit 30 of configuration information of a section 3 (step S107). A delay information acquisition unit 43-3 of the section control unit 40-3 acquires delay information of a path through which a packet passes among paths in the section 3 at a constant cycle (step S108). Each time the delay information is acquired, the delay information acquisition unit 43-3 outputs the acquired delay information to a switching determination unit 44-3.

An NW information acquisition unit 45-3 of the section control unit 40-3 acquires NW information of a path through which no packet passes at present in the section 3 at a constant cycle (step S109). Each time the NW information is acquired, the NW information acquisition unit 45-3 outputs the acquired NW information to a switching destination selection unit 46-3. Each time the NW information acquired from the NW information acquisition unit 45-3, the switching destination selection unit 46-3 selects a switching destination path.

The NW configuration collection units 32-1 to 32-3 of the integrated control unit 30 acquire configuration information of each section transmitted from the respective section control units 40-1 to 40-3 (step S110). For example, the NW configuration collection unit 32-n acquires configuration information of the section n transmitted from the section control unit 40-n. The NW configuration collection unit 32-n outputs the acquired configuration information of the section n to the section SLA calculation unit 33-n. The section SLA calculation unit 33-n calculates a minimum section SLA value of the section n on the basis of the configuration information output from the NW configuration collection unit 32-n (step S111). The section SLA calculation unit 33-n outputs the calculated minimum section SLA value of the section n to the section SLA optimization unit 34.

The section SLA optimization unit 34 determines an optimal section SLA value of each section on the basis of the minimum section SLA value of the section n output from each section SLA calculation unit 33-n and the SLA value held by the SLA value holding unit 31 (step S112). Specifically, when the total sum of the minimum section SLA values of each section and the SLA value held by the SLA value holding unit 31 are the same value, the section SLA optimization unit 34 determines the minimum section SLA value of each section as the optimal section SLA value of each section. On the other hand, when the total sum of the minimum section SLA values of each section is less than the SLA value, the section SLA optimization unit 34 determines the optimal section SLA value of each section by adding a value obtained by proportionally dividing a surplus to the minimum section SLA value of each section. The section SLA optimization unit 34 outputs information on the optimal section SLA value of each section to the section SLA notification unit 35.

The section SLA notification unit 35 notifies the section control units 40-1 to 40-3 of information on the optimal section SLA value of each section output from the section SLA optimization unit 34. The section SLA notification unit 35 notifies the section control unit 40-1 of the information on the optimal section SLA value of the section 1 output from the section SLA optimization unit 34 (step S113). Similarly, the section SLA notification unit 35 notifies the section control unit 40-2 of the information on the optimal section SLA value of the section 2 output from the section SLA optimization unit 34 (step S114). Similarly, the section SLA notification unit 35 notifies the section control unit 40-3 of the information on the optimal section SLA value of the section 3 output from the section SLA optimization unit 34 (step S115).

A section SLA value acquisition unit 41-1 of the section control unit 40-1 acquires the optimal section SLA value of the section 1 notified by the integrated control unit 30 (step S116). The section SLA value acquisition unit 41-1 notifies the switching determination unit 44-1 and a switching destination determination unit 47-1 of the acquired optimal section SLA value of the section 1. The switching determination unit 44-1 determines whether or not switching of the path is necessary on the basis of the optimal section SLA value of the section 1 notified from the section SLA value acquisition unit 41-1 and the value of delay indicated by the latest delay information obtained from the delay information acquisition unit 43-1 (step S117). Here, it is assumed that it is determined that switching of the path of the section 1 is necessary. The switching determination unit 44-1 outputs a notification indicating that the switching of the path is necessary to the switching destination determination unit 47-1.

The switching destination determination unit 47-1 determines one candidate path from the latest candidate paths notified from the switching destination selection unit 46-1 as a switching destination path in response to the notification output from the switching determination unit 44-1 (step S118). The switching destination determination unit 47-1 notifies a switching destination instruction unit 48-1 of information on the determined switching destination path. The switching destination instruction unit 48-1 generates a switching instruction including the information of the switching destination path notified from the switching destination determination unit 47-1. The switching destination instruction unit 48-1 instructs switching of a transfer path of the packet in the section 1 by transmitting the generated switching instruction to the communication device 20 in the section managed by the section control unit 40 (step S119).

The switching instruction transmitted from the switching destination instruction unit 48-1 is received by the communication devices 20-1 and 20-4 belonging to the section 1. The communication devices 20-1 and 20-4 transfer packets through the path included in the switching instruction.

Similarly, a section SLA value acquisition unit 41-2 of the section control unit 40-2 acquires the optimal section SLA value of the section 2 notified by the integrated control unit 30 (step S120). The section SLA value acquisition unit 41-2 notifies the switching determination unit 44-2 and a switching destination determination unit 47-2 of the acquired optimal section SLA value of the section 2. The switching determination unit 44-2 determines whether or not switching of the path is necessary on the basis of the optimal section SLA value of the section 2 notified from the section SLA value acquisition unit 41-2 and the value of delay indicated by the latest delay information obtained from the delay information acquisition unit 43-2 (step S121). Here, it is assumed that it is determined that switching of the path of the section 2 is necessary. The switching determination unit 44-2 outputs a notification indicating that the switching of the path is necessary to the switching destination determination unit 47-2.

The switching destination determination unit 47-2 determines one candidate path from the latest candidate paths notified from the switching destination selection unit 46-2 as a switching destination path in response to the notification output from the switching determination unit 44-2 (step S122). The switching destination determination unit 47-2 notifies a switching destination instruction unit 48-2 of information on the determined switching destination path. The switching destination instruction unit 48-2 generates a switching instruction including the information of the switching destination path notified from the switching destination determination unit 47-2. The switching destination instruction unit 48-2 instructs switching of a transfer path of the packet in the section 2 by transmitting the generated switching instruction to the communication device 20 in the section managed by the section control unit 40 (step S123).

The switching instruction transmitted from the switching destination instruction unit 48-2 is received by the communication devices 20-4 and 20-7 belonging to the section 2. The communication devices 20-4 and 20-7 transfer packets through the path included in the switching instruction.

Similarly, a section SLA value acquisition unit 41-3 of the section control unit 40-3 acquires the optimal section SLA value of the section 3 notified by the integrated control unit 30 (step S124). The section SLA value acquisition unit 41-3 notifies the switching determination unit 44-3 and a switching destination determination unit 47-3 of the acquired optimal section SLA value of the section 3. The switching determination unit 44-3 determines whether or not switching of the path is necessary on the basis of the optimal section SLA value of the section 3 notified from the section SLA value acquisition unit 41-3 and the value of delay indicated by the latest delay information obtained from the delay information acquisition unit 43-3 (step S125). Here, it is assumed that it is determined that switching of the path of the section 3 is unnecessary. In this case, the section control unit 40-3 does not control the switching of the path of the section 3.

The flowcharts illustrated in FIGS. 5 and 6 show a configuration in which after the section control units 40-1 to 40-3 acquire the delay information and the NW information, the integrated control unit 30 determines the optimal section SLA value of each section, and the section control units 40-1 to 40-3 acquire the optimal section SLA value of each section, and determine whether or not switching of the path is necessary and switch the path when the switching of the path is necessary. The flow of the processing illustrated in FIGS. 5 and 6 is an example, and the processing may not be performed in the order illustrated in FIGS. 5 and 6. For example, in the section control units 40-1 to 40-3, it is not necessary to synchronize the cycle of acquisition of the optimal section SLA value with the cycle of switching after receiving the acquisition of the delay information. The section control units 40-1 to 40-3 acquire delay information and NW information at a constant cycle, and the information on the optimal section SLA value is acquired by transmission from the integrated control unit 30. In this way, in the section control units 40-1 to 40-3, the cycle of acquisition of the optimal section SLA value and the cycle of acquisition of the delay information and the NW information are independent, and therefore they do not necessarily need to be synchronized. The section control units 40-1 to 40-3 only need to determine whether or not switching of the path is necessary on the basis of the latest optimal section SLA value and the latest delay time that they hold. It is not necessary for the section control units 40-1 to 40-3 to acquire the delay information and the NW information in the same cycle.

According to the communication system 100 configured as described above, even when delay increases in a communication device through which a packet passes, it is possible to provide a service that satisfies a guaranteed delay time. Specifically, the communication system 100 includes the plurality of section control units 40 that perform path control for each of sections with a network having a detour, the sections being obtained by partitioning the communication system, and the integrated control unit 30 that controls the plurality of section control units 40. The integrated control unit 30 includes the section SLA optimization unit 34 that determines an optimal guaranteed delay time for each section to satisfy an end-to-end guaranteed delay time provided by a service, and the section SLA notification unit 35 that notifies the plurality of section control units of the determined optimal guaranteed delay time for each section, and the plurality of section control units 40 each include the switching destination instruction unit 48 that instructs a switching destination to switch to a path satisfying the optimal guaranteed delay time notified from the integrated control unit 30. Thus, since path control is enabled for each section, switching processing to a path having a shorter delay time can be handled more immediately. Therefore, even when delay increases in a communication device through which a packet passes, it is possible to provide a service that satisfies a guaranteed delay time.

Modification examples of the communication system 100 will be described below.

### Modification Example 1

In the above-described embodiment, a configuration in which the integrated control unit 30 calculates the optimal section SLA value of each section using the result of calculation of the minimum section SLA value of each section by the section SLA calculation units 33-1 to 33-N has been shown. The integrated control unit 30 may be configured to calculate an optimal section SLA value of each section without calculating a minimum section SLA value of each section. In such a configuration, the integrated control unit 30 does not need to include the section SLA calculation units 33-1 to 33-N, or the NW configuration collection units 32-1 to 32-N and the section SLA calculation units 33-1 to 33-N. When the integrated control unit 30 does not include the section SLA calculation units 33-1 to 33-N, the section SLA optimization unit 34 of the integrated control unit 30 determines an optimal section SLA value of each section on the basis of the configuration information of each section obtained from the NW configuration collection units 32-1 to 32-N and the SLA value held by the SLA value holding unit 31. For example, the section SLA optimization unit 34 determines an optimal section SLA value of each section by allocating more SLA values held by the SLA value holding unit 31 to a section where it is estimated that there is a high likelihood that the status of the network will fluctuate by referring to the configuration information than to a section where there is a low likelihood that the status of the network will fluctuate.

When the integrated control unit 30 does not include the NW configuration collection units 32-1 to 32-N and the section SLA calculation units 33-1 to 33-N, the section SLA optimization unit 34 of the integrated control unit 30 determines an optimal section SLA value of each section by equally allocating the SLA value held by the SLA value holding unit 31 to each section. For example, when the SLA value is “180 ms” and the section is partitioned into three sections, the section SLA optimization unit 34 determines “60 ms” as the optimal section SLA value of each section.

### Modification Example 2

Each section control unit 40 may be included in the configuration of the integrated control unit 30 and may be configured as a path control device.

### Modification Example 3

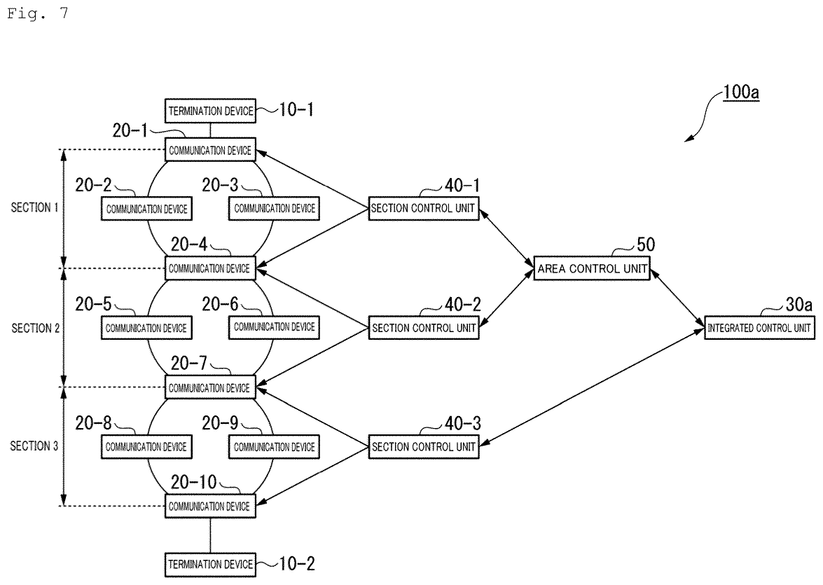

When there are a plurality of section control units 40, as illustrated in FIG. 7, an area control unit 50 may be provided between the integrated control unit 30 and the plurality of section control units 40 to form a hierarchical structure. FIG. 7 is a diagram illustrating a configuration example of a communication system 100a according to a modification example. The communication system 100a includes the plurality of termination devices 10-1 and 10-2, the plurality of communication devices 20-1 to 20-10, an integrated control unit 30a, the plurality of section control units 40-1 to 40-3, and an area control unit 50. The area control unit 50 collects information from the plurality of section control units 40 (section control units 40-1 and 40-2 in FIG. 7), and transmits the collected information to the integrated control unit 30a. The operation of the integrated control unit 30a is basically the same as that of the integrated control unit 30. The operation of the integrated control unit 30a is different from that of the integrated control unit 30 in that the section control unit 40 is controlled through the area control unit 50. Other configurations are the same as those of the communication system 100.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention is applicable to the communication system which transfers a packet within an end-to-end distance.

### REFERENCE SIGNS LIST

10, 10-1 and 10-2 Termination device
20, 20-1 to 20-10 Communication device
30 Integrated control unit
40, 40-1 to 40-3 Section control unit
31 SLA value holding unit
32, 32-1 to 32-N NW configuration collection unit
33, 33-1 to 33-N Section SLA calculation unit
34 Section SLA optimization unit
35 Section SLA notification unit
41 Section SLA value acquisition unit
42 Configuration information acquisition unit
43 Delay information acquisition unit
44 Switching determination unit
45 NW information acquisition unit
46 Switching destination selection unit
47 Switching destination determination unit
48 Switching destination instruction unit

1. A communication system in which a plurality of networks each having a detour within an end-to-end distance are formed, the communication system comprising:
a plurality of section control units that perform path control for each of sections with a network having a detour, the sections being obtained by partitioning the communication system; and
an integrated control unit that controls the plurality of section control units, wherein the integrated control unit includes
a processor: and
a storage medium having computer program instructions stored thereon, when executed by the processor, perform to:
that determines an optimal guaranteed delay time for each section to satisfy an end-to-end guaranteed delay time provided by a service, and
that notifies the plurality of section control units of the optimal guaranteed delay time for each section, and the plurality of section control units each include
a switching destination instruction unit that instructs a switching destination to switch to a path satisfying the optimal guaranteed delay time notified from the integrated control unit.

2. The communication system according to claim 1, wherein the computer program instructions further perform to
collects configuration information regarding a configuration of each section from each of the plurality of section control units, and
calculates a minimum required guaranteed delay time for each section on the basis of the collected configuration information, and the optimization unit determines the optimal guaranteed delay time for each
the guaranteed delay time and the minimum required guaranteed delay time for each section.

3. The communication system according to claim 2, wherein the computer program instructions further determines the minimum required guaranteed delay time for each section as the optimal guaranteed delay time for each section when a total sum of the minimum required guaranteed delay times for each section is the same value as the guaranteed delay time.

4. The communication system according to claim 2, wherein the computer program instructions further determines the optimal guaranteed delay time for each section by adding a value obtained by proportionally dividing a surplus to the minimum required guaranteed delay time for each section when a total sum of the minimum required guaranteed delay times for each section is less than the guaranteed delay time.

5. The communication system according to claim 4, wherein the computer program instructions further determines the optimal guaranteed delay time for each section by adding, to the minimum required guaranteed delay time for each section, any of a value obtained by equally allocating a surplus to each section, a value obtained by allocating the surplus according to a proportion of minimum required guaranteed delay time for each section, and a value allocated according to a degree of likelihood that a status of a network of each section will fluctuate.

6. The communication system according to claim 1, wherein
the plurality of section control units each further include
a delay information acquisition unit that acquires information regarding a delay time of a path through which a packet passes among paths in a managed section, and
a switching determination unit that determines whether or not switching of a path is necessary on the basis of the optimal guaranteed delay time notified from the integrated control unit and the delay time, and
the switching destination instruction unit instructs the switching destination to switch to the path satisfying the optimal guaranteed delay time when the switching determination unit determines that switching of the path is necessary.

7. A path control device in a communication system in which a plurality of networks each having a detour within an end-to-end distance are formed, the communication system being partitioned into a plurality of sections with a network having a detour, and
the path control device comprising:
an optimization unit that determines an optimal guaranteed delay time for each section to satisfy an end-to-end guaranteed delay time provided by a service; and
a switching destination instruction unit that instructs a switching destination for each section to switch to a path satisfying the optimal guaranteed delay time determined by the optimization unit.

8. A path control method in a communication system in which a plurality of networks each having a detour within an end-to-end distance are formed, the communication system being partitioned into a plurality of sections with a network having a detour, and
the path control method comprising:
determining an optimal guaranteed delay time for each section to satisfy an end-to-end guaranteed delay time provided by a service; and
instructing a switching destination for each section to switch to a path satisfying the determined optimal guaranteed delay time.
